(19) United States
(12) Patent Application Publication
(10) Pub. No.: US 2016/0284349 A1
(43) Pub. Date: Sep. 29, 2016

(54) METHOD AND SYSTEM OF ENVIRONMENT SENSITIVE AUTOMATIC SPEECH RECOGNITION

(71) Applicants: Binuraj Ravindran, Cupertino, CA (US); Georg Stemmer, Munchen (DE); Joachim Hofer, Munich (DE)

(72) Inventors: Binuraj Ravindran, Cupertino, CA (US); Georg Stemmer, Munchen (DE); Joachim Hofer, Munich (DE)

(21) Appl. No.: 14/670,355

(22) Filed: Mar. 26, 2015

(51) Int. Cl. G10L 15/22; G10L 15/20; G10L 25/84; G10L 25/48; G10L 21/02; G10L 25/03

(52) U.S. Cl. CPC G10L 15/22; G10L 21/0205; G10L 25/03; G10L 25/84; G10L 25/48; G10L 15/20; G10L 2021/02087

(57) ABSTRACT

A system, article, and method of environment-sensitive automatic speech recognition.

### BACKGROUND

Speech recognition systems, or automatic speech recognizers, have become increasingly important as more and more computer-based devices use speech recognition to receive commands from a user in order to perform some action as well as to convert speech into text for dictation applications or even hold conversations with a user where information is exchanged in one or both directions. Such systems may be speaker-dependent, where the system is trained by having the user repeat words, or speaker-independent where anyone may provide immediately recognized words. Some systems also may be configured to understand a fixed set of single word commands, such as for operating a mobile phone that understands the terms “call” or “answer”, or an exercise wrist-band that understands the word “start” to activate a timer for example.

Thus, automatic speech recognition (ASR) is desirable for wearables, smartphones, and other small devices. Due to the computational complexity of ASR, however, many ASR systems for small devices are server based such that the computations are performed remotely from the device, which can result in a significant delay. Other ASR systems that have on-board computation ability also are too slow, provide relatively lower quality word recognition, and/or consume too much power of the small devices to perform the computations. Thus, a good quality ASR system that provides fast word recognition with lower power consumption is desired.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram showing an automatic speech recognition system;

FIG. 2 is a schematic diagram showing an environment-sensitive system to perform automatic speech recognition;

FIG. 3 is a flow chart of an environment-sensitive automatic speech recognition process;

FIG. 4 is a detailed flow chart of an environment-sensitive automatic speech recognition process;

FIG. 5 is a graph comparing word error rate (WERs) to real-time factor (RTF) depending on the signal-to-noise ratio (SNR);

FIG. 6 is a table for ASR parameter modification showing beamwidth compared to WERs and RTFs, and depending on SNRs;

FIG. 7 is a table of ASR parameter modification showing acoustic scale factors compared to word error rates and depending on the SNR;

FIG. 8 is a table of example ASR parameters for one point on the graph of FIG. 5 and comparing acoustic scale factor, beam width, current token buffer size, SNR, WER, and RTF;

FIG. 9 is a schematic diagram showing an environment-sensitive ASR system in operation;

FIG. 10 is an illustrative diagram of an example system;

FIG. 11 is an illustrative diagram of another example system; and

FIG. 12 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as mobile devices including smartphones, and wearable devices such as smartwatches, smart-wrist bands, smart headsets, and smart glasses, but also laptop or desk top computers, video game panels or consoles, television set top boxes, dictation machines, vehicle or environmental control systems, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein may also be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods of environment-sensitive automatic speech recognition.

Battery life is one of the most critical differentiating features of small computer devices such as a wearable device, and especially those with always-on-audio activation paradigms. Thus, extending the battery life of these small computer devices is very important.

Automatic Speech Recognition (ASR) is typically used on these small computer devices to receive commands to perform a certain task such as initiate or answer a phone call, search for a keyword on the internet, or start timing an exercise session to name a few examples. ASR, however, is a computationally demanding, communication heavy, and data intensive workload. When wearable devices support embedded, stand-alone, medium or large vocabulary ASR capability without the help from remote tethered devices like a smart phone, tablet, etc. with larger battery capacities, battery life extension is especially desirable. This is true even though ASR computation is a transient, rather than continuous workload since the ASR will apply a heavy computational load and memory access when the ASR is activated.

To avoid these disadvantages and extend the battery life on small devices using ASR, environment-sensitive ASR methods presented herein optimize ASR performance indicators and reduce the computation load of the ASR engine to extend the battery life on wearable devices. This is accomplished by dynamically selecting the ASR parameters based on the environment in which an audio capture device (such as a microphone) is being operated. Specifically, ASR performance indicators like word error rate (WER) and real time factor (RTF) for example can vary significantly depending on the environment at or around the device capturing the audio that forms ambient noise characteristics as well as speaker variations and different parameters of the ASR itself. WER is a common metric of the accuracy of an ASR. It may be computed as the relative number of recognition errors in the ASR's output given the number of spoken words. Falsely inserted words, deleted words or substitution of one spoken word by another are counted as recognition errors. RTF is a common metric of the processing speed or performance of the ASR. It may be computed by dividing the time needed for processing an utterance by the duration of the utterance.

When the environment is known to the ASR system beforehand, the ASR parameters can be tuned in such a way as to reduce the computational load (thus reduction in RTF), and in turn the energy consumed, without significant reduction in quality (corresponding to an increase in the WER). Alternatively, the environment-sensitive methods may improve performance such that the computational load may be relatively maintained to increase quality and speed. Information about the environment around the microphone can be obtained by analyzing the captured audio signal, obtaining other sensor data about the location of the audio device and activity of a user holding the audio device, as well as other factors such as using a profile of the user as explained below. The present methods may use this information to adjust ASR parameters and including: (1) adjustment of a noise reduction algorithm during feature extraction depending on the environment, (2) selection of an acoustic model that de-emphasizes one or more particular identified sounds or noise in the audio data, (3) application of acoustic scale factors to the acoustic scores provided to a language model depending on the SNR of the audio data and a user's activity, (4) the setting of other ASR parameters for a language model such as beamwidth and/or current token buffer size also depending on the SNR of the audio data and/or user activity, and (5) selection of a language model that uses weighting factors to emphasize a relevant sub-vocabulary based on the environmental information of the user and his/her physical activity. Each of these parameters is explained below. Most of these parameter refinements may raise the efficiency of the ASR when environmental information permits the ASR to reduce the search size without a significant drop in quality and speed such as when the audio has relatively lower noise or identifiable noise that may be eliminated from the speech, or when a target relevant sub-vocabulary is identified for the search. Thus, the parameters may be tuned to obtain desirable or acceptable performance indicator values while reducing or throttling the computational load of the ASR engine. The details of the present ASR system and methods are explained below.

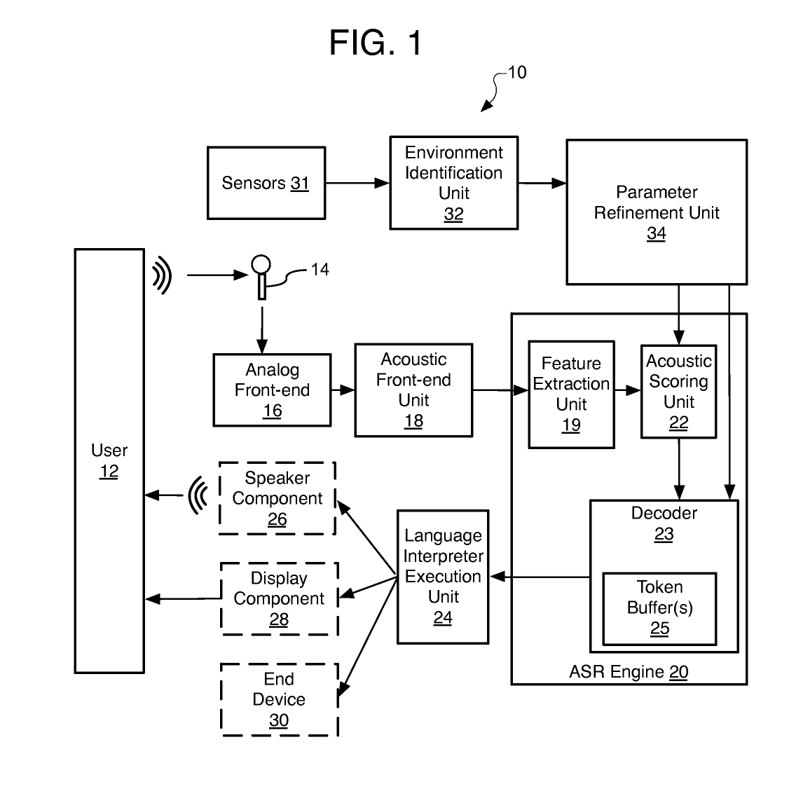

Referring now to FIG. 1, an environment-sensitive automatic speech recognition system 10 may be a speech enabled human machine interface (HMI). While system 10 may be, or may have, any device that processes audio, speech enabled HMIs are especially suitable for devices where other forms of user input (keyboard, mouse, touch, and so forth) are not possible due to size restrictions (e.g. on a smartwatch, smart glasses, smart exercise wrist-band, and so forth). On such devices, power consumption usually is a critical factor making highly efficient speech recognition implementations necessary. Here, the ASR system 10 may have an audio capture or receiving device 14, such as a microphone for example, to receive sound waves from a user 12, and that converts the waves into a raw electrical acoustical signal that may be recorded in a memory. The system 10 may have an analog front end 16 that provides analog pre-processing and signal conditioning as well as an analog/digital (A/D) converter to provide a digital acoustic signal to an acoustic front-end unit 18. Alternatively, the microphone unit may be digital connected directly through a two wire digital interface such as a pulse density modulation (PDM) interface. In this case, a digital signal is directly fed to the acoustic front end 18. The acoustic front-end unit 18 may perform pre-processing which may include signal conditioning, noise cancelling, sampling rate conversion, signal equalization, and/or pre-emphasis filtration to flatten the signal. The acoustic front-end unit 18 also may divide the acoustic signal into frames, by 10 ms frames by one example. The pre-processed digital signal then may be provided to a feature extraction unit 19 which may or may not be part of an ASR engine or unit 20. The feature extraction 19 unit may perform, or maybe linked to a voice activity detection unit (not shown) that performs, voice activation detection (VAD) to identify the endpoints of utterances as well as linear prediction, mel-cepstrum, and/or additives such as energy measures, and delta and acceleration coefficients, and other processing operations such as weight functions, feature vector stacking and transformations, dimensionality reduction and normalization. The feature extraction unit 19 also extracts acoustic features or feature vectors from the acoustic signal using Fourier transforms and so forth to identify phonemes provided in the signal. Feature extraction may be modified as explained below to omit extraction of undesirable identified noise. An acoustic scoring unit 22, which also may or may not be considered part of the ASR engine 20, then uses acoustic models to determine a probability score for the context dependent phonemes that are to be identified.

For the environment-sensitive operations performed herein, an environment identification unit 32 may be provided and may include algorithms to analyze the audio signal such as to determine a signal-to-noise ratio or to identify specific sounds in the audio such as a user's heavy breathing, wind, crowd or traffic noise to name a few examples. Otherwise, the environment identification unit 32 may have, or receive data from, one or more other sensors 31 that identify a location of the audio device, and in turn the user of the device, and/or an activity being performed by the user of the device such as exercise. These indications of the identified environment from the sensors then may be passed to a parameter refinement unit 34 that compiles all of the sensor information, forms a final (or more-final) conclusion as to the environment around the device, and determines how to adjust the parameters of the ASR engine, and particularly, at least at the acoustic scoring unit and/or decoder to more efficiently (or more accurately) perform the speech recognition.

Specifically, as explained below, depending on the signal-to-noise ratio (SNR), and in some cases the user activity as well, an acoustic scale factor (or multiplier) may be applied to all of the acoustic scores before the scores are provided to the decoder to factor the clarity of the signal relative to the ambient noise as explained in detail below. The acoustic scale factor influences the relative reliance on acoustic scores compared to language model scores. It may be beneficial to change the influence of the acoustic scores on the overall recognition result depending on the amount of noise that is present. Additionally, acoustic scores may be refined (including zeroed) to emphasize or de-emphasize certain sounds identified from the environment (such as wind or heavy breathing) to effectively act as a filter. This latter sound-specific parameter refinement will be referred to as selecting an appropriate acoustic model so as not to be confused with the SNR based refinement.

A decoder 23 uses the acoustic scores to identify utterance hypotheses and compute their scores. The decoder 23 uses calculations that may be represented as a network (or graph or lattice) that may be referred to as a weighted finite state transducer (WFST). The WFST has arcs (or edges) and states (at nodes) interconnected by the arcs. The arcs are arrows that extend from state-to-state on the WFST and show a direction of flow or propagation. Additionally, the WFST decoder 23 may dynamically create a word or word sequence hypothesis, which may be in the form of a word lattice that provides confidence measures, and in some cases, multiple word lattices that provide alternative results. The WFST decoder 23 forms a WFST that may be determinized, minimized, weight or label pushed, or otherwise transformed (e. g. by sorting the arcs by weight, input or output symbol) in any order before being used for decoding. The WFST may be a deterministic or a non-deterministic finite state transducer that may contain epsilon arcs. The WFST may have one or more initial states, and may be statically or dynamically composed from a lexicon WFST (L) and a language model or a grammar WFST (G). Alternatively, the WFST may have lexicon WFST (L) which may be implemented as a tree without an additional grammar or language model, or the WFST may be statically or dynamically composed with a context sensitivity WFST (C), or with a Hidden Markov Model (HMM) WFST (H) that may have HMM transitions, HMM state IDs, Gaussian Mixture Model (GMM) densities, or deep neural networks (DNNs) output state IDs as input symbols. After propagation, the WFST may contain one or more final states that may have individual weights. The WFST decoder 23 uses known specific rules, construction, operation, and properties for single-best speech decoding, and the details of these that are not relevant here are not explained further in order to provide a clear description of the arrangement of the new features described herein. The WFST based speech decoder used here may be one similar to that as described in “Juicer: A Weighted Finite-State Transducer Speech Decoder” (Moore et al., 3^{rd} Joint Workshop on Multimodal Interaction and Related Machine Learning Algorithms MLMI'06).

A hypothetical word sequence or word lattice may be formed by the WFST decoder by using the acoustic scores and token passing algorithms to form utterance hypotheses. A single token represents one hypothesis of a spoken utterance and represents the words that were spoken according to that hypothesis. During decoding, several tokens are placed in the states of the WFST, each of them representing a different possible utterance that may have been spoken up to that point in time. At the beginning of decoding, a single token is placed in the start state of the WFST. During discrete points in time (so called frames), each token is transmitted along, or propagates along, the arcs of the WFST. If a WFST state has more than one outgoing arc, the token is duplicated, creating one token for each destination state. If the token is passed along an arc in the WFST that has a non-epsilon output symbol (i.e., the output is not empty, so that there is a word hypothesis attached to the arc), the output symbol may be used to form a word sequence hypothesis or word lattice. In a single-best decoding environment, it is sufficient to only consider the best token in each state of the WFST. If more than one token is propagated into the same state, recombination occurs where all but one of those tokens are removed from the active search space so that several different utterance hypotheses are recombined into a single one. In some forms, the output symbols from the WFST may be collected, depending on the type of WFST, during or after the token propagation to form one most likely word lattice or alternative word lattices.

Relevant here, the environment identification unit 32 also may provide information to the parameter refinement unit 34 to refine the parameters for the decoder 23 and language model as well. Specifically, each transducer has a beamwidth and a current token buffer size that can be modified also depending on the SNR and to select a suitable tradeoff between WER and RTF. The beamwidth parameter is related to the breadth-first search for the best sentence hypothesis which is a part of the speech recognition process. In each time instance, a limited number of best search states are kept. The larger the beamwidth, the more states are retained. In other words, the beamwidth is the maximum number of tokens represented by states and that can exist on the transducer at any one instance in time. This may be controlled by limiting the size of the current token buffer, which matches the size of the beamwidth, and holds the current states of the tokens propagating through the WFST.

Another parameter of the WFST is the transition weights of the arcs which can be modified to emphasize or de-emphasize a certain relevant sub-vocabulary part of a total available vocabulary for more accurate speech recognition when a target sub-vocabulary is identified by the environment identification unit 32. The weighting then may be adjusted as determined by the parameter refinement unit 34. This will be referred to as selecting the appropriate vocabulary-specific language model. Otherwise, the noise reduction during feature extraction may be adjusted depending on the user activity as well and as explained below.

The output word lattice or lattices (or other form of output hypothetical sentence or sentences) are made available to a language interpreter and execution unit (or interpretation engine) 24 to determine the user intent. This intent determination or spoken utterance classification may be based on decision trees, form filling algorithms or statistical classification (e. g. using support-vector networks (SVNs) or deep neural networks (DNNs)).

Once the user intent is determined for an utterance, the interpretation engine 24 also may output a response or initiate an action. The response may be in audio form through a speaker component 26, or in visual form as text on a display component 28 for example. Otherwise, an action may be initiated to control another end device 30 (whether or not considered as part of, or within, the same device as the speech recognition system 10). For example, a user may state “call home” to activate a phone call on a telephonic device, the user may start a vehicle by stating words into a vehicle fob, or a voice mode on a smartphone or smartwatch may initiate performance of certain tasks on the smartphone such as a keyword search on a search engine or initiate timing of an exercise session for the user. The end device 30 may simply be software instead of a physical device or hardware or any combination thereof, and is not particularly limited to anything except to have the ability to understand a command or request resulting from a speech recognition determination and to perform or initiate an action in light of that command or request.

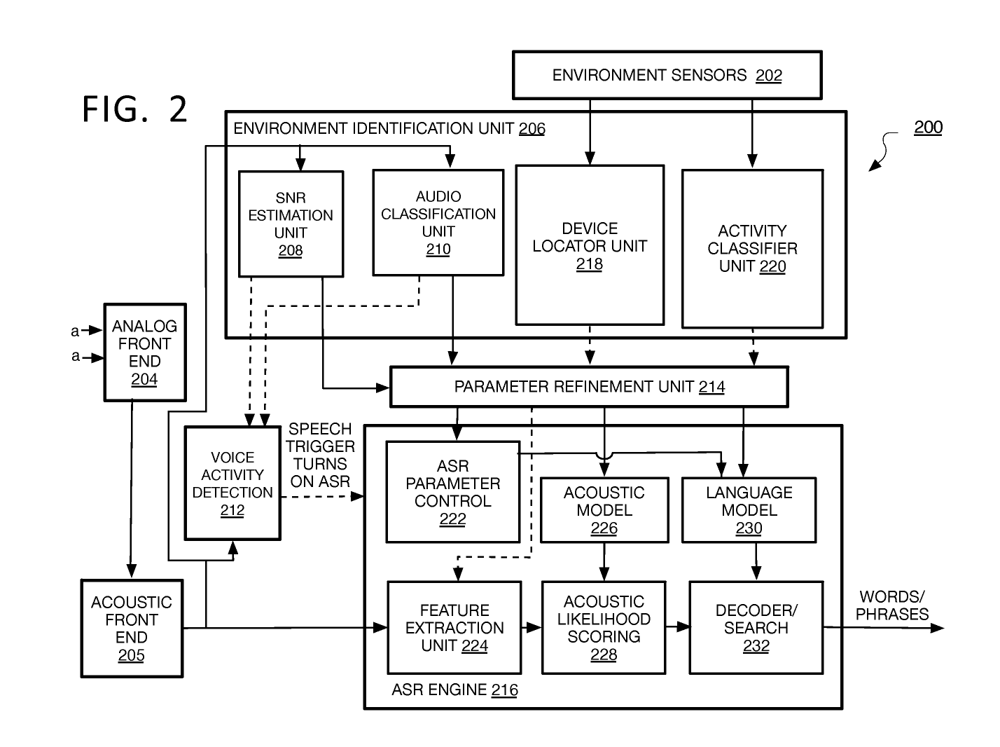

Referring to FIG. 2, an environment-sensitive ASR system 200 is shown with a detailed environment identification unit 206 and ASR engine 216. An analog front end 204 receives and processes the audio signal as explained above for analog front end 16 (FIG. 1), and an acoustic front end 205 receives and processes the digital signal as with the acoustic front end 18. By one form, feature extraction unit 224, as with feature extraction unit 19, may be performed by the ASR engine. Feature extraction may not occur until voice or speech is detected in the audio signal.

The processed audio signal is provided from the acoustic front end 205 to an SNR estimation unit 208 and audio classification unit 210 that may or may not be part of the environment identification unit 206. The SNR estimation unit 208 computes the SNR for the audio signal (or audio data). Also, an audio classification unit 210 is provided to identify known non-speech patterns, such as wind, crowd noise, traffic, airplane, or other vehicle noise, heavy breathing by the user and so forth. This may also factor a provided or learned profile of the user such as gender to indicate a lower or higher voice. By one option, this indication or classification of audio sounds and the SNR may be provided to a voice activity detection unit 212. The voice activity detection unit 212 determines whether speech is present, and if so, activates the ASR engine, and may activate the sensors 202 and the other units in the environment identification unit 206 as well. Alternatively, the system 10 or 200 may remain in an always-on monitoring state constantly analyzing incoming audio for speech.

Sensor or sensors 202 may be provide sensed data to the environment identification unit for ASR, but also may be activated by other applications or may be activated by the voice activity detection unit 212 as needed. Otherwise, the sensors also may have an always-on state.

The sensors may include any sensor that may indicate information about the environment in which the audio signal or audio data was captured. This includes sensors to indicate the position or location of the audio device, in turn suggesting the location of the user, and presumably the person talking into the device. This may include a global positioning system (GPS) or similar sensor that may identify the global coordinates of the device, the geographic environment near the device (hot desert or cold mountains), whether the device is inside of a building or other structure, and the identification of the use of the structure (such as a health club, office building, factory, or home). This information may be used to deduce the activity of the user as well, such as exercising. The sensors 202 also may include a thermometer and barometer (which provides air pressure and that can be used to measure altitude) to provide weather conditions and/or to refine the GPS computations. A photo diode (light detector) also may be used to determine whether the user is outside or inside or under a particular kind or amount of light.

Other sensors may be used to determine the position and motion of the audio device relative to the user. This includes a proximity sensor that may detect whether the user is holding the device to the user's face like a phone, or a galvanic skin response (GSR) sensor that may detect whether the phone is being carried by the user at all. Other sensors may be used to determine whether the user is running or performing some other exercise such as an accelerometer, gyroscope, magnetometer, ultrasonic reverberation sensor, or other motion sensor, or any of these or other technologies that form a pedometer. Other health related sensors such as electronic heart rate or pulse sensors, and so forth, also may be used to provide information about the user's current activity.

Once the sensor(s) provide sensor data to the environment identification unit 206, a device locator unit 218 may use the data to determine the location of the audio device and then provide that location information to a parameter refinement unit 214. Likewise, an activity classifier unit 220 may use the sensor data to determine an activity of the user and then provide the activity information to the parameter refinement unit 214 as well.

The parameter refinement unit 214 compiles much or all of the environment information, and then uses the audio and other information to determine how to adjust the parameters for the ASR engine. Thus, as explained herein, the SNR is used to determine refinement to the beamwidth, an acoustic scale factor, and a current token buffer size limitation. These determinations are passed to an ASR parameter control 222 in the ASR engine for implementation on the ongoing audio analysis. The parameter refinement unit also receives noise identification from the audio classification unit 210 and determines which acoustic models (or in other words which modifications to the acoustic score computations) best de-emphasizes the undesirable identified sound or sounds (or noise), or to emphasize a certain sound as a low male voice of the user.

Otherwise, the parameter refinement unit 214, may use the location and activity information to identify a particular vocabulary relevant to the current activity of the user. Thus, the parameter refinement unit 214 may have a list of pre-defined vocabularies, such as for specific exercise sessions such as running or biking, and that may be emphasized by selecting an appropriate running-based sub-vocabulary language model, for example. The acoustic model 226 and language model 230 units respectively receive the selected acoustic, and language models to be used for propagating the tokens through the models (or lattices when in lattice form). Optionally, the parameter refinement unit 214 can modify, by intensifying, noise reduction of an identified sound during feature extraction as well. Thus, in processing order, feature extraction may occur to the audio data with or without modified noise reduction of an identified sound. Then, an acoustic likelihood scoring unit 228 may perform acoustic scoring according to the selected acoustic model. Thereafter, acoustic scale factor(s) may be applied before the scores are provided to the decoder. The decoder 232 may then use the selected language model, adjusted by the selected ASR parameters such as beamwidth and token buffer size, to perform the decoding. It will be appreciated that the present system may provide just one of these parameter refinements or any desired combination of the refinements. Hypothetical words and/or phrases may then be provided by the ASR engine.

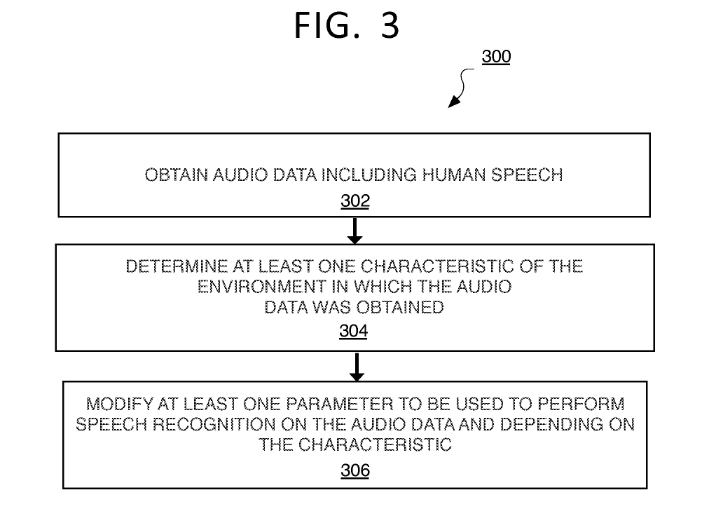

Referring to FIG. 3, an example process 300 for a computer-implemented method of speech recognition is provided. In the illustrated implementation, process 300 may include one or more operations, functions or actions as illustrated by one or more of operations 302 to 306 numbered evenly. By way of non-limiting example, process 300 may be described herein with reference to any of example speech recognition devices of FIGS. 1, 2, and 9-12, and where relevant.

Process 300 may include “obtain audio data including human speech” 302, and particularly, an audio recording or live streaming data from one or more microphones for example.

Process 300 may include “determine at least one characteristic of the environment in which the audio data was obtained” 304. As explained in more detail herein, the environment may refer to the location and surroundings of the user of the audio device as well as the current activity of the user. Information about the environment may be determined by analyzing the audio signal itself to establish an SNR (that indicates whether the environment is noisy) as well as identify the types of sound (such as wind) in the background or noise of the audio data. The environment information also may be obtained from other sensors that indicate the location and activity of the user as described herein.

Process 300 may include “modify at least one parameter used to perform speech recognition on the audio data and depending on the characteristic” 306. Also as explained in greater detail herein, the parameters used to perform the ASR engine computations using the acoustic models and/or language models may be modified depending on the characteristic in order to reduce the computational load or increase the quality of the speech recognition without increasing the computational load. For one optional example, noise reduction during feature extraction may avoid extraction of an identified noise or sound. For other examples, identity of the types of sounds in the noise of the audio data, or identification of the user's voice, may be used to select an acoustic model that de-emphasizes undesired sounds in the audio data. Also, the SNR of the audio as well as the ASR indicators (such as WER and RTF mentioned above) then may be used to set acoustic scale factors to refine the acoustic scores from the acoustic model, as well as the beamwidth value and/or current token buffer size to use on the language model. The identified activity of the user then may be used to select the appropriate vocabulary-specific language model for the decoder. These parameter refinements result in a significant reduction in the computational load to perform the ASR.

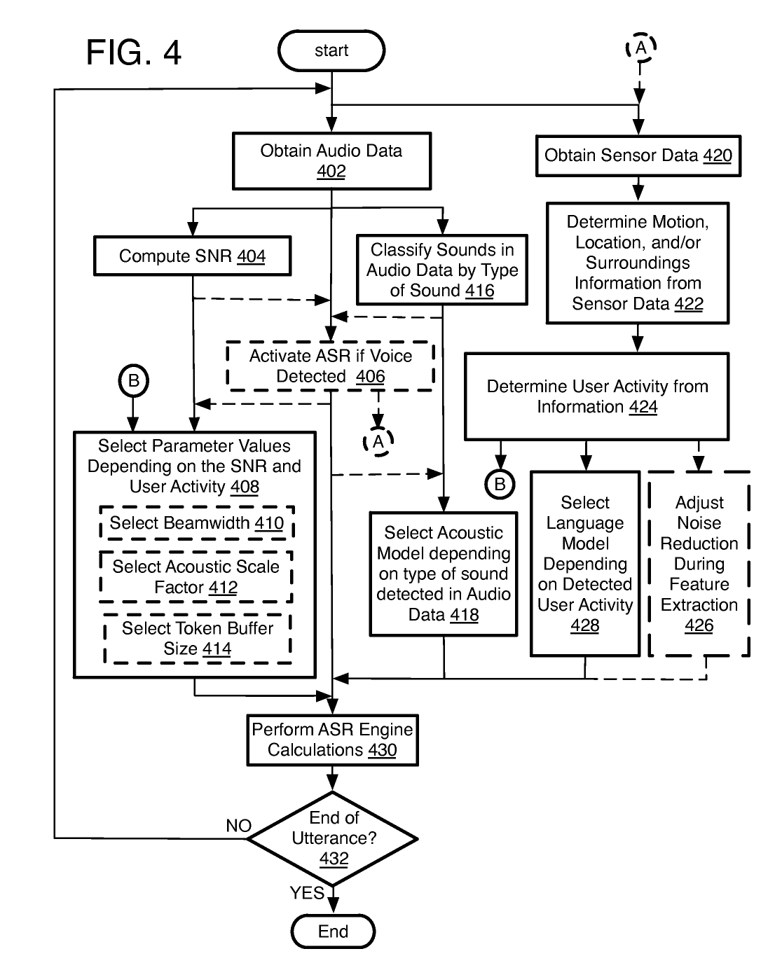

Referring to FIG. 4, an example computer-implemented process 400 for environment-sensitive automatic speech recognition is provided. In the illustrated implementation, process 400 may include one or more operations, functions or actions as illustrated by one or more of operations 402 to 432 numbered evenly. By way of non-limiting example, process 400 may be described herein with reference to any of example speech recognition devices of FIGS. 1, 2, and 10-12, and where relevant.

The present environment-sensitive ASR process takes advantage of the fact that a wearable or mobile device typically may have many sensors that provide extensive environment information and the ability to analyze the background noise of the audio captured by microphones to determine environment information relating to the audio to be analyzed for speech recognition. Analysis of the noise and background of the audio signal coupled with other sensor data may permit identification of the location, activities, and surroundings of the user talking into the audio device. This information can then be used to refine the ASR parameters which can assist in reducing the computational load requirements for ASR processing and therefore to improve the performance of the ASR. The details are provided as follows.

Process 400 may include “obtain audio data including human speech” 402. This may include reading audio input from acoustic signals captured by one or more microphones. The audio may be previously recorded or may be a live stream of audio data. This operation may include cleaned or pre-processed audio data that is ready for ASR computations as described above.

Process 400 may include “compute SNR” 404, and particularly determine the signal-to-noise ratio of the audio data. The SNR may be provided by a SNR estimation module or unit 208 and based on the input from the audio frontend in an ASR system. The SNR may be estimated by using known methods such as global SNR (GSNR), segmental SNR (SSNR) and arithmetic SSNR (SSNRA). Well known definition of SNR for speech signal is ratio of the signal power to the noise power during the speech activity expressed in the logarithmic domain as in the following equation. SNR=10*log₁₀(S/N) where S is the estimated signal power when the speech activity is present and N is the noise power during the same time, which is expressed as global SNR. However, as speech signal is process in small frames of 10 ms to 30 ms each, the SNR is estimated for each of these frames and averaged over time. For SSNR, the averaging is done across the frames after taking the logarithm of ratio for each frame. For SSNRA, the logarithm computation is done after the averaging of the ratio across the frames, simplifying the computation. In order to detect the speech activity, there are multiple techniques that are employed, such as time domain, frequency domain and other feature based algorithms, which are well known to whoever is skilled in this art.

Optionally, process 400 may include “activate ASR if voice detected” 406. By one optional form, the ASR operations are not activated unless a voice or speech is first detected in the audio in order to extend battery life. Typically, the voice-activity-detection triggers, and the speech recognizer is activated in a babble noise environment when no single voice can be accurately analyzed for speech recognition. This causes battery consumption to increase. Instead, environment information about the noise may be provided to the speech recognizer to activate a second stage or alternate voice-activity-detection that has been parameterized for the particular babble noise environment (e.g. using a more aggressive threshold). This will keep the computational load low until the user is speaking.

Known voice activity detection algorithms vary depending on the latency, accuracy of voice detection, computational cost etc. These algorithms may work on time-domain or frequency domain and may involve a noise reduction/noise estimation stage, feature extraction stage and classification stage to detect the voice/speech. Comparison of the VAD algorithms are provided by Xiaoling Yang, Hubei Univ. of Technol., Wuhan, China Baohua Tan, Jiehua Ding, Jinye Zhang, Comparative Study on Voice Activity Detection Algorithm. The classifying of the types of sound is explained in more detail with operation 416. These considerations used to activate the ASR systems may provide a much more precise voice activation system that significantly reduces wasted energy by avoiding activation when no or little recognizable speech is present.

Once it is determined that at least one voice with recognizable speech is present in the audio, the ASR system may be activated. Alternatively, such activation may be omitted, and the ASR system may be in always-on mode for example. Either way, activating the ASR system may include modifying noise reduction during feature extraction, using the SNR to modify ASR parameters, using the classified background sounds to select an acoustic model, using other sensor data to determine an environment of the device and select a language model depending on the environment, and finally activating the ASR engine itself. Each of these functions are detailed below.

Process 400 may include “select parameter values depending on the SNR and the user activity” 408. As mentioned, there are multiple parameters in the ASR engine which can be adjusted to optimize the performance based on the above. Some examples include beamwidth, acoustic scale factor, and current token buffer size. Additional environment information such as the SNR that indicates the noisiness of the background of the audio can be exploited to further improve the battery life by adjusting some of the key parameters, even when the ASR is active. The adjustments can reduce algorithm complexity and data processing and in turn the computational load when the audio data is clear and it is easier to determine a user's words on the audio data.

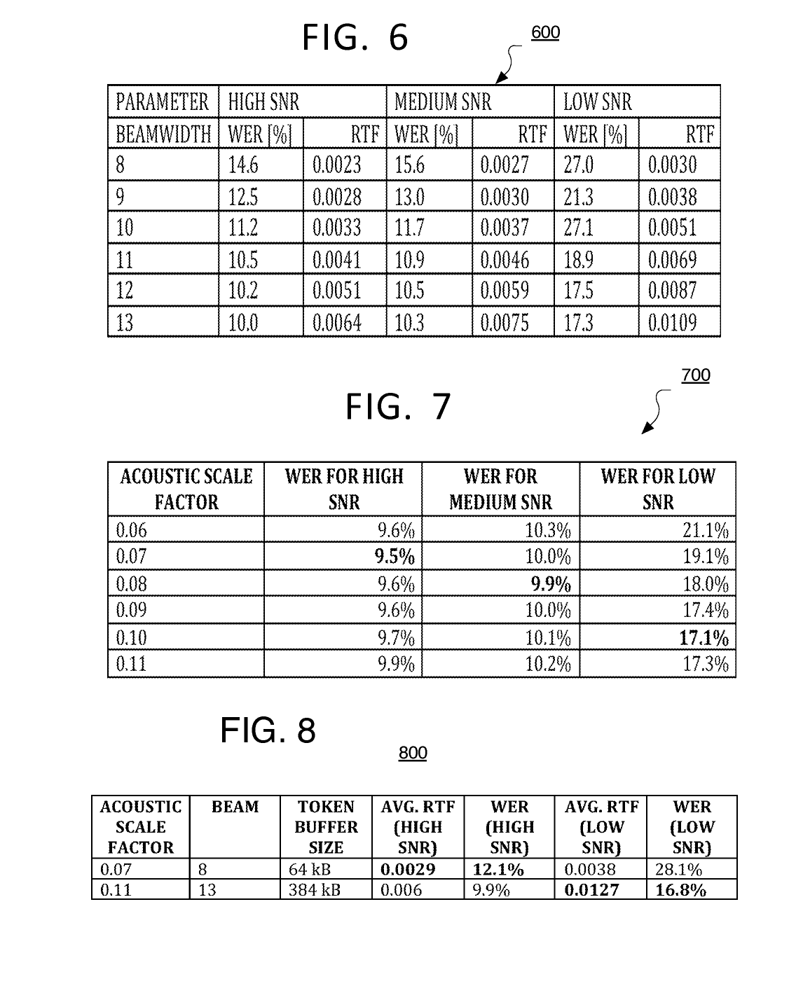

When the quality of the input audio signal is good (the audio is clear with low noise level for example), the SNR will be large, and when the quality of the input audio signal is bad (the audio is very noisy), the SNR will be small. If the SNR is sufficiently large to allow an accurate speech recognition, many of the parameters can be relaxed to reduce the computational load. One example of relaxing the parameter is reducing the beam width from 13 to 11 and thus reducing the RTF or the computational load from 0.0064 to 0.0041 with only 0.5% reduction in the WER as in FIG. 6 when SNR is high. Alternatively, if the SNR is small and the audio is very noisy, these parameters can be adjusted in such a way that the maximum performance is still achieved albeit at the expense of more energy and less battery life. For example, as shown in FIG. 6, when the SNR is low, increasing the beam width to 13 so that WER of 17.3% can be maintained at the expense of higher RTF (or increased energy).

By one form, the parameter values are selected by modifying the SNR values or settings depending on the user activity. This may occur when the user activity obtained at operation 424 suggests one type of SNR should be present (high, medium, or low) but the actual SNR is not what is expected. In this case, an override may occur and the actual SNR values may be ignored or adjusted to use SNR values or an expected SNR setting (of high, medium, or low SNR).

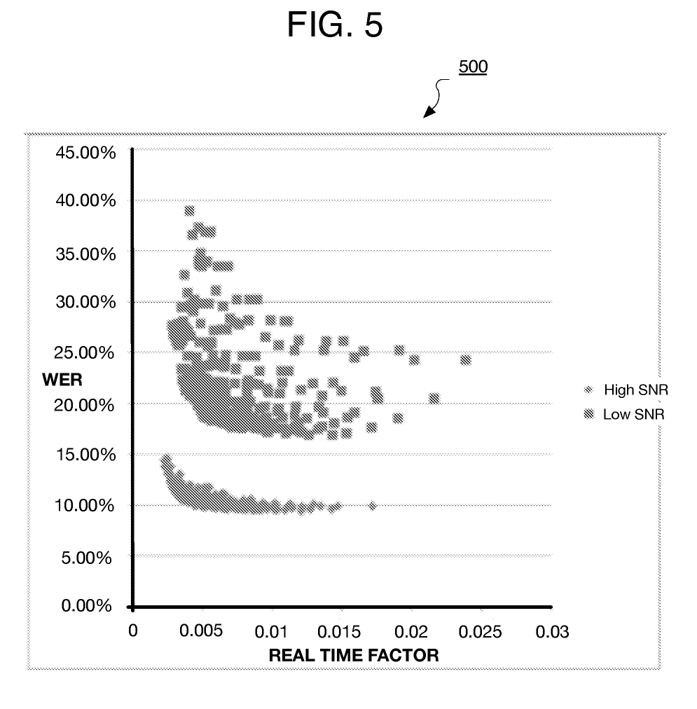

Referring to FIG. 5, the parameters may be set by determining which parameter values are most likely to achieve desired ASR indicator values and specifically Word Error Rate (WER) and average Real-time-factor (RTF) values as introduced above. As mentioned, WER may be the number of recognition errors over the number of spoken words, and RTF may be computed by dividing the time needed for processing an utterance by the duration of the utterance. RTF has direct impact on the computational cost and response time, as this determines how much time ASR takes to recognize the words or phrases. A graph 500 shows the relationship between WER and RTF for a speech recognition system on a set of utterances at different SNR levels and for various settings of the ASR parameters. Three different ASR parameters were changed—beamwidth, acoustic scale factor, and token size. The graph is a parameter grid search over the acoustic scale factor, beamwidth, and token size for high and low SNR scenarios, and the graph shows the relationship between WER and RTF when the three parameters are varied across their ranges. In order to perform this search or experiment, one parameter was varied at a specific step size, while keeping the other two parameters constant and capturing the values of RTF and WER. The experiment was repeated for the other two parameters by varying only one parameter at a time and keeping the other two parameters constant. After all the data is collected, the plot was generated by merging all the results and plotting the relationship between WER and RTF. The experiment was repeated for High SNR and Low SNR scenarios. For example, acoustic scale factor was varied from 0.05 to 0.11 in steps of 0.01, while keeping the values of beam width and token size constant. Similarly, the beam width was varied from 8 to 13 in steps of 1, keeping the acoustic scale factor and token size the same. Again, the token size was varied from 64k to 384k, keeping the acoustic scale factor and the beam width the same.

On the graph 500, the horizontal axis is the RTF, and the vertical axis is the WER. There are two different series for low and high SNR scenarios. For both the low and high SNR scenarios, an optimal point exists in the graph (see FIG. 8 discussed below) with the lowest RTF for the specific values of the three dependent variables that are adjusted. Lower values of WER correspond to higher accuracy, and lower values of RTF correspond to less compute costs or reduced battery usage. As it is usually not possible to minimize both metrics at the same time, often the parameters are selected to keep the average RTF around 0.5% (0.005 on table 600) for all SNR levels while minimizing the WER. Any further RTF reduction yields reduced battery consumption.

Referring to FIG. 6, process 400 may include “select beamwidth” 410. Typically, for larger beamwidth settings, the ASR becomes more accurate but slower, i.e. WER decreases and RTF increases, and vice versa for smaller values of the beamwidth. Conventionally, the beamwidth is set to a fixed value for all SNR levels. Experimental data showing the different WER and RTF values for different beamwidths is provided on table 600. This chart was created to illustrate the effect of beamwidth on the WER and RTF. To generate this chart, the beamwidth was varied from 8 to 13 in steps of 1, and the WER and RTF were measured for three different scenarios, namely High SNR, medium SNR and low SNR. As shown, when beamwidth equals 12, the WER is close to optimal across all SNR levels where the high and medium WER values are less than the typically desired 15% maximum, and the low SNR scenario provides 17.5%, just 2.5% higher than 15%. The RTF is close to the 0.005 target for high and medium SNR although the low SNR is at 0.0087 showing that when the audio signal is noisy, the system slows to obtain even a decent WER.

Instead of maintaining the same beamwidth for all SNR values, however, the use of the environment information such as the SNR as described herein permits selection of an SNR-dependent beamwidth parameter. For instance, the beamwidth may be set to 9 for higher SNR conditions while maintained at 12 for low SNR conditions. For the high SNR situation, reducing the beamwidth from the conventional fixed beamwidth setting 12 to 9 maintains the accuracy at acceptable levels (12.5% WER which is less than 15%) while achieving a much reduced compute cost for high SNR conditions as evidenced by the lower RTF from 0.0051 at beamwidth 12 to 0.0028 at beamwidth 9. Yet, for low SNR, where optimal WER becomes more important to achieve decent usability, the beamwidth is maximized (at 12) and the RTF is permitted to increase to 0.0087 as mentioned above.

The experiments described above can be performed in a simulated environment or a real hardware device. When performed in a simulated environment, the audio files with different SNR scenarios can be pre-recorded, and the ASR parameters can be adjusted through a scripting language where these parameters are modified by the scripts. The ASR engine can be operated by using these modified parameters. In a real hardware device, special computer programs can be implemented to modify the parameters and perform the experiments at different SNR scenarios like outdoors, indoors, etc. to capture the WER and RTF values.

Referring to FIG. 7, process 400 also may include “select acoustic scale factor” 412. Another parameter that can be modified is the acoustic scale factor based on the acoustic conditions, or in other words, based on the information about the environment as revealed by the SNR for example and around the audio device as it picked up the sound waves and formed audio signals. The acoustic scale factor determines the weighting between acoustic and language model scores. It has little impact on the decoding speed but is important to achieve good WERs. Table 700 provides experimental data including a column of possible acoustic scale factors and the WER for different SNRs (high, medium, and low). These values were obtained from experiments with equivalent audio recordings under different noise conditions, and the table 700 shows that recognition accuracy may be improved by using different acoustic scale factors based on SNR.

As mentioned, the acoustic scale factor may be a multiplier that is applied to all of the acoustic scores outputted from an acoustic model. By other alternatives, the acoustic scale factors could be applied to a subset of all acoustic scores, for example those that represent silence or some sort of noise. This may be performed if a specific acoustic environment is identified in order to emphasize acoustic events that are more likely to be found in such situations. The acoustic scale factor may be determined by finding the acoustic scale factor that minimizes the word error rate on a set of development speech audio files that represent the specific audio environments.

By yet another form, acoustic scale factor may be adjusted based on other environmental and contextual data, like for example, when the device user is involved in an outdoor activity like running, biking, etc. where the speech can be consumed in the wind noise and traffic noise and breathing noise. This context can be obtained by the information from the inertial motion sensors and information obtained from the ambient audio sensors. In this example, an acoustic scale factor of a certain value may be provided that is lower to de-emphasize non-speech sounds. Such non-speech sounds could be heavy breathing when it is detected that the user is exercising for example, or the wind if it is detected the user is outside. The acoustic scale factors for these scenarios are obtained by collecting a large audio data set for the selected environmental contexts (running with wind noise, running without wind noise, biking with traffic noise, biking without traffic noise, etc.) explained above and empirically determining the right acoustic scale factors to reduce the WER.

Referring to FIG. 8, a table 800 shows the data of two example, specific, optimal points selected from graph 500 with one for each SNR scenario (high and low shown on graph 500). The WER is maintained below 12% for high SNR and below 17% for low SNR while maintaining the RTF reasonably low with a maximum of 0.6 for the noisy audio that is likely to require a heavier computational load for good quality speech recognition. Also regarding FIG. 8, the effect of token size may be noted. Specifically, in high SNR scenarios, a smaller token size also reduces the energy consumption such that a smaller memory (or token) size limitation results in less memory access and hence lower energy consumption.

It will be appreciated that the ASR system may refine beamwidth alone, acoustic scale factor alone, or both, or provide the option to refine either. To determine which options are used, a development set of speech utterances that was not used for training the speech recognition engine can be used. The parameters that give the best tradeoff between recognition rate and computational speed depending on the environmental conditions may be determined using an empirical approach. Any of these options are likely to consider both WER and RTF as discussed above.

It should be noted that RTF shown that the experiments used to determine the RTF values herein and on the graph 500 and tables 600, 700, and 800 are based on ASR algorithms running on multi-core desktop PCs and laptops clocked at 2-3 GHz. On a wearable devices, however, the RTF should have much larger values generally in the range of approximately 0.3% to 0.5% (depending on what other programs are running on the processor) with the processors running at clock speeds less than 500 MHz and hence higher potential of load reduction with dynamic ASR parameters.

By another alternative, process 400 may include “select token buffer size” 414. Thus, in addition to selecting beamwidth and/or acoustic scale factor, a smaller token buffer size may be set to significantly reduce the maximum number of simultaneous active search hypotheses that can exist on a language model, which in turn reduces the memory access, and hence the energy consumption. In other words, the buffer size is the number of tokens that can be processed by the language transducer at any one time point. The token buffer size may have an influence on the actual beamwidth if a histogram pruning or similar adaptive beam pruning approach is used. As explained above for the acoustic scale factor and the beamwidth, the token buffer size may be selected by evaluating the best compromise between WER and RTF on a development set.

In addition to determining the SNR, the ASR process 400 may include “classify sounds in audio data by type of sound” 416. Thus, microphone samples in the form of audio data from the analog frontend also may be analyzed in order to identify (or classify) sounds in the audio data including voice or speech as well as sounds in the background noise of the audio. As mentioned above, the classified sounds may be used to determine the environment around the audio device and user of the device for lower power-consuming ASR as well as to determine whether to activate ASR in the first place as described above.

This operation may include comparing the desired signal portion of the incoming or recorded audio signals with learned speech signal patterns. These may be standardized patterns or patterns learned during use of an audio device by a particular user.

This operation also may include comparing other known sounds with pre-stored signal patterns to determine if any of those known types or classes of sounds exists in the background of the audio data. This may include audio signal patterns associated with wind, traffic or individual vehicle sounds whether from the inside or outside of an automobile, or airplane, crowds of people such as talking or cheering, heavy breathing as from exercise, other exercise related sounds such as from a bicycle or treadmill, or any other sound that can be identified and indicates the environment around the audio device. Once the sounds are identified, the identification or environment information may be provided for use by an activation unit to activate the ASR system as explained above and when a voice or speech is detected, but is otherwise provided to be de-emphasized in the acoustic model.

This operation also may include confirmation of the identification sound type by using the environment information data from the other sensors, which is explained in greater detail below. Thus, for example, if heavy breathing is found in the audio data, it may be confirmed that the audio is in fact heavy breathing by using the other sensors to find environment information that the user is exercising or running. By one form, if no confirmation exists, then the acoustic model will not be selected based on the possibly heavy breathing sound alone. This confirmation process may occur for each different type or class of sound. In other forms, confirmation is not used.

Otherwise, process 400 may include “select acoustic model depending on type of sound detected in audio data” 418. Based on the audio analysis, an acoustic model may be selected that filters out or de-emphasizes the identified background noise, such as heavy breathing, so that the audio signal providing the voice or speech is more clearly recognized and emphasized.

This may be accomplished by the parameter refinement unit and by providing relatively lower acoustic scores to the phoneme of the identified sounds in the audio data. Specifically, the a-priori probability of acoustic events like heavy breathing may be adjusted based on whether the acoustic environment contains such events. If for example heavy breathing was detected in the audio signal, the a-priori probability of acoustic scores relating to such events are set to values that represent the relative frequency of such events in an environment of that type. Thus, the refinement of the parameter here (the acoustic scores) is effectively a selection of a particular acoustic model each de-emphasizing a different sound or combinations of sounds in the background. The selected acoustic model, or indication thereof, is provided to the ASR engine. This more efficient acoustic model ultimately leads the ASR engine to the appropriate words and sentences with less computational load and more quickly thereby reducing power consumption.

To determine the environment of an audio device and the device's user, process 400 also may include “obtain sensor data” 420. As mentioned, many of the existing wearable devices like fitness-wrist bands, smart watches, smart headsets, smart glasses, and other audio devices such as smartphones, and so forth collect different kinds of user data from integrated sensors like an accelerometer, gyroscope, barometer, magnetometer, galvanic skin response (GSR) sensor, proximity sensor, photo diode, microphones, and cameras. In addition, some of the wearable devices will have location information available from the GPS receivers, and/or WiFi receivers, if applicable.

Process 400 may include “determine motion, location, and/or surroundings information from sensor data” 422. Thus, the data from the GPS and WiFi receiver may indicate the location of the audio device which may include the global coordinates and whether the audio device is in a building that is a home or specific type of business or other structure that indicates certain activities such as a health club, golf course, or sports stadium for example. The galvanic skin response (GSR) sensor may detect whether the device is being carried by the user at all, while a proximity sensor may indicate whether the user is holding the audio device like a phone. As mentioned above, other sensors may be used to detect motion of the phone, and in turn the motion of the user like a pedometer or other similar sensor when it is determined that the user is carrying/wearing the device. This may include an accelerometer, gyroscope, magnetometer, ultrasonic reverberation sensor, or other motion sensor that sensed patterns like back and forth motions of the audio device and in turn certain motions of the user that may indicate the user is running, biking, and so forth. Other health related sensors such as electronic heart rate or pulse sensors, and so forth, also may be used to provide information about the user's current activity.

The sensor data also could be used in conjunction with pre-stored user profile information such as the age, gender, occupation, exercise regimen, hobbies, and so forth of the user, and that may be used to better identify the voice signal versus the background noise, or to identify the environment.

Process 400 may include “determine user activity from information” 424. Thus, a parameter refinement unit may collect all of the audio signal analysis data including the SNR, audio speech and noise identification, and sensor data such as the likely location and motions of the user, as well as any relevant user profile information. The unit then may generate conclusions regarding the environment around the audio device and the user of the device. This may be accomplished by compiling all of the environment information and comparing the collected data to pre-stored activity-indicating data combinations that indicate a specific activity. Activity classification based on the data from motion sensors are well known as described by Mohd Fikri Azli bin Abdullah, Ali Fahmi Perwira Negara, Md. Shohel Sayeed, Deok-Jai Choi, Kalaiarasi Sonai Muthu et al. in Classification Algorithms in Human Activity i Recognition using Smartphones, pp 372-379 of “World Academy of Science, Engineering and Technology Vol:6 2012 Aug. 27”. Similarly, audio classification is also well studied area. Lie Lu, Hao Jiang and HongJiang Zhang from Microsoft research (research.microsoft.com/pubs/69879/tr-2001-79.pdf) shows a method based on kNN (k-nearest neighbor) and rule based approach for audio classification. All classification problems involve the extraction of the key features (time domain, frequency domain, etc.) which represents the classes (physical activities, audio classes like speech, non-speech, music, noise, etc.) and using classification algorithms like rule-based approaches, kNN, HMM and other artificial neural network algorithms to classify the data. During the classification process, the feature templates saved during the training phase for each class will be compared with the generated features to decide the closest match. The output from the SNR detection block, activity classification, audio classification, other environmental information like location can be then combined to generate more accurate and high level abstraction about the user. If the physical activity detected in swimming, the back-ground noise detected is swimming pool noise and the water sensor shows positive detection, it can be confirmed that the user is definitely swimming. This will allow the ASR to be adjusted to the swimming profile which adjusts the language models to the swimming and also update the acoustic scale factor, beam width and token size to this specific profile.

To provide a few examples, in one situation the SNR is low, the audio analysis indicates a heavy breathing sound and/or other outdoor sounds, and the other sensors indicate a running motion of the feet along an outdoor bike path. In this case, a fairly confident conclusion may be reached that the user is running outdoors. In a slightly modified case, it may be concluded the user is biking outdoors in wind when a wind sound is detected in the audio and the motion sensors detect fast motion at known biking speeds of the audio device and/or user along the bike path. Likewise, when the audio device is moving at vehicle-like speeds and traffic noise is present and detected moving along roadways, the conclusion may be reached that the user is in a vehicle, and depending on known volume levels, might even conclude whether the vehicle windows are opened or closed. In other examples, when the user is not detected in contact with the audio device which is detected inside a building with offices, and possibly a specific office with WiFi, and a high SNR, it may be concluded that the audio device is placed down to be used as a loud speaker (and it may be possible to determine that loud speaker mode is activated on the audio device) and that the user is idle in a relatively quiet (low noise-high SNR) environment. Many other possible examples exist.

Process 400 may include “select language model depending on detected user activity” 428. As mentioned, one aspect of this invention is to collect and exploit the relevant data available from the rest of the system to tune the performance of the ASR and reduce the computational load. The examples given above concentrate on acoustical differences between different environments and usage situations. The speech recognition process also becomes less complex and thus more computationally efficient when it is possible to constrain the search space (of the available vocabulary) by using the environment information to determine what is and is not the likely sub-vocabulary that the user will use. This may be accomplished by increasing the weight values in the language models for words that are more likely to be used and/or decreasing the weights for the words that will not be used in light of the environment information. One conventional method example that is limited to information related to searching for a physical location on a map for example is to weight different words (e.g. addresses, places) in the vocabulary as provided by Bocchieri, Caseiro: Use of Geographical Meta-data in ASR Language and Acoustic models, pp 5118-5121 of “2010 IEEE International Conference on Acoustics Speech and Signal Processing (ICASSP)”. In contrast, however, the present environment-sensitive ASR process is much more efficient since a wearable device “knows” much more about the user than just the location. For instance, when the user is actively doing the fitness activity of running, it becomes more likely that phrases and commands uttered by the user are related to this activity. The user will ask “what is my current pulse rate” often during a fitness activity but almost never while sitting at home in front of the TV. Thus, the likelihood for words and word sequences depends on the environment in which the words were stated. The proposed system architecture allows the speech recognizer to leverage the environment information (e.g. activity state) of the user to adapt the speech recognizer's statistical models to match better to the true probability distribution of the words and phrases the user can say to the system. During a fitness activity, for example, the language model will have an increased likelihood for words and phrases from the fitness domain (“pulse rate”) and a reduced likelihood for words from other domains (“remote control”). On average, an adapted language model will lead to less computational effort of the speech recognition engine and therefore reduce the consumed power.

Modifying the weights of the language model depending on a more likely sub-vocabulary determined from the environment information may effectively be referred to as selecting a language model that is tuned for that particular sub-vocabulary. This may be accomplished by pre-defining a number of sub-vocabularies and matching the sub-vocabularies to a possible environment (such as a certain activity or location, and so forth of the user and/or the audio device). When an environment is found to be present, the system will retrieve the corresponding sub-vocabulary and set the weights of the words in that sub-vocabulary at more accurate values.

In addition to determining a sub-vocabulary, it will be appreciated that the environment information from the location, activity, and other sensors also may be used to assist with identifying sounds for the acoustic data analysis as well as to assist with feature extraction from the pre-processed acoustic data and before the acoustic models are generated. For example, the proposed system could enable wind noise reduction in the feature extraction when the system detects that the user moved outside. Thus, process 400 also may optionally include “adjust noise reduction during feature extraction depending on environment” 426.

Also as mentioned, the parameter setting unit used here will analyze all of the environment information from all of the available sources so that an environment may be confirmed by more than one source, and if one source of information is deficient, the unit may emphasize information from another source. By yet another alternative, while the parameters may be adjusted based on the SNR itself, the parameter refinement unit may use the additional environment information data collected from the different sensors in an over-ride mode for the ASR system to optimize the performance for that particular environment. For example, if the user is moving, it would be assumed that the audio should be relatively noisy if no SNR is provided or even though the SNR is high and conflicts with the sensor data. In this case, the SNR maybe ignored and the parameters may be made stringent (strictly setting the parameter values to maximum search capacity levels to search the entire vocabularies, and so forth). This permits a lower WER to result in order to prioritize obtaining a good quality recognition over speed and power efficiency. This is performed by monitoring the “user activity information” 424 and identifying when the user is in motion, whether it is running, walking, biking, swimming etc., in addition to SNR monitoring. As mentioned previously, if there is motion detected, the ASR parameter values are set at operation 408 similar to what would have been set when the SNR is low and medium, even though the SNR was detected to be very high. This is to ensure that a minimum WER can be achieved, even in scenarios where the spoken words are difficult to be detected as they may be slightly modified by the user activity.

Process 400 may include “perform ASR engine calculations” 430, and particularly may include (1) adjusting the noise reduction during feature extraction when certain sounds are assumed to be present due to the environment information, (2) using the selected acoustic model to generate acoustic scores for phoneme and/or words extracted from the audio data and that emphasize or de-emphasize certain identified sounds, (3) adjusting the acoustic scores with the acoustic scale factors depending on SNR, (4) setting the beamwidth and/or current token buffer size for the language model, and (5) selecting the language model weights depending on the detected environment. All of these parameter refinements result in a reduction in computational load when the speech is easier to recognize and increase the computational load when the speech is more difficult to recognize, ultimately resulting in an overall reduction in consumed power and in turn, extended battery life.

The language model may be a WFST or other lattice-type transducer, or any other type of language model that uses acoustic scores and/or permits the selection of the language model as described herein. By one approach, the feature extraction and acoustic scoring occurs before the WFST decoding begins. By another example, the acoustic scoring may occur just in time. If scoring is performed just in time, it may be performed on demand, such that only scores that are needed during WFST decoding are computed.

The core token passing algorithm used by such a WFST may include deriving an acoustic score for the arc that the token is traveling, which may include adding the old (prior) score plus arc (or transition) weight plus acoustic score of a destination state. As mentioned above, this may include the use of a lexicon, a statistical language model or a grammar and phoneme context dependency and HMM state topology information. The generated WFST resource may be a single, statically composed WFST or two or more WFSTs to be used with dynamic composition.

Process 400 may include “end of utterance?” 432. If the end of the utterance is detected, the ASR process has ended, and the system may continue monitoring audio signals for any new incoming voice. If the end of the utterance has not occurred yet, the process loops to analyze the next portion of the utterance at operation 402 and 420.

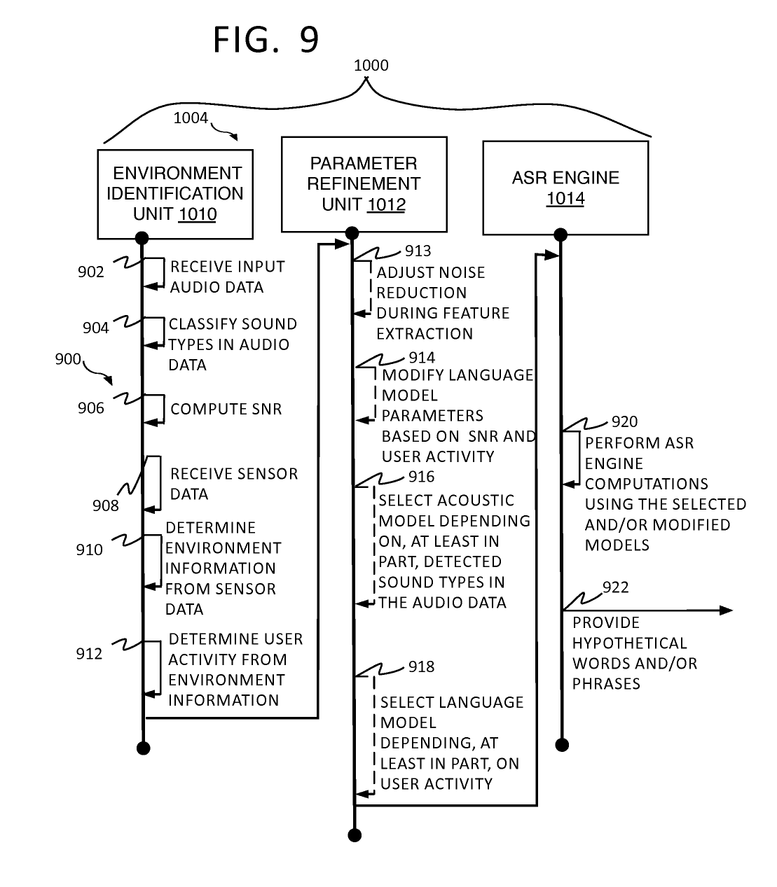

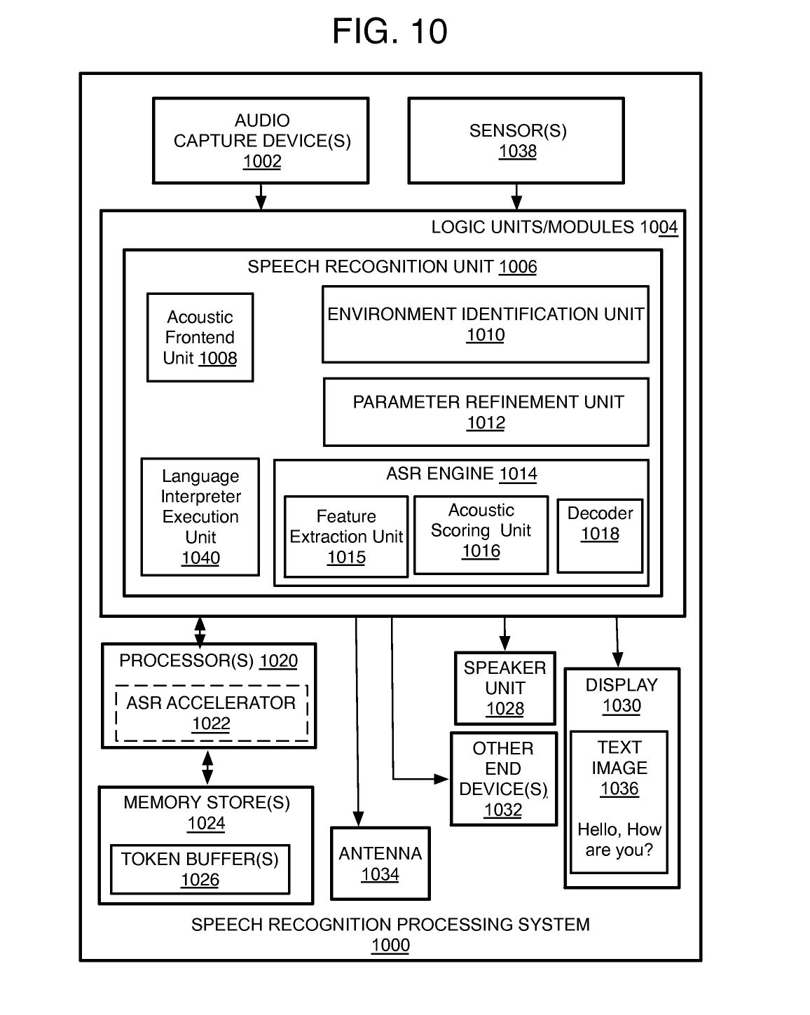

Referring to FIG. 9, by another approach, process 900 illustrates one example operation of a speech recognition system 1000 that performs environment-sensitive automatic speech recognition including environment identification, parameter refinement, and ASR engine computations in accordance with at least some implementations of the present disclosure. In more detail, in the illustrated form, process 900 may include one or more operations, functions, or actions as illustrated by one or more of actions 902 to 922 numbered evenly. By way of non-limiting example, process 900 will be described herein with reference to FIG. 10. Specifically, system or device 1000 includes logic units 1004 that includes a speech recognition unit 1006 with an environment identification unit 1010, a parameter refinement unit 1012, and an ASR engine or unit 1014 along with other modules. The operation of the system may be described as follows. Many of the details for these operations are already explained in other places herein.

Process 900 may include “receive input audio data” 902, which may be pre-recorded or streaming live data. Process 900 then may include “classify sound types in audio data” 904. Particularly, the audio data is analyzed as mentioned above to identify non-speech sounds to be de-emphasized or voices or speech to better clarify the speech signal. By one option, the environment information from other sensors may be used to assist in identifying or confirming the sound types present in the audio as explained above. Also, process 900 may include “compute SNR” 906, and of the audio data.

Process 900 may include “receive sensor data” 908, and as explained in detail above, the sensor data may be from many different sources that provide information about the location of the audio device and the motion of the audio device and/or motion of the user near the audio device.

Process 900 may include “determine environment information from sensor data” 910. Also as explained above, this may include determining the suggested environment from individual sources. Thus, these are the intermediate conclusions about whether a user is carrying the audio device or not, or holding the device like a phone, the location is inside or outside, the user is moving in a running motion or idle and so forth.

Process 900 may include “determine user activity from environment information” 912, which is the final or more-final conclusion regarding the environment information from all of the sources regarding the audio device location and the activity of the user. Thus, this may be a conclusion that, to use one non-limiting example, a user is running fast and breathing hard outside on a bike path in windy conditions. Many different examples exist.

Process 900 may include “modify the noise reduction during feature extraction” 913, and before providing the features to the acoustic model. This may be based on the sound identification or other sensor data information or both.

Process 900 may include “modify language model parameters based on SNR and user activity” 914. The actual SNR settings maybe used to set the parameters if these setting do not conflict with the expected SNR settings when a certain user activity is present (such as being outdoors in the wind). Setting of the parameters may include modifying the beamwidth, acoustic scale factors, and/or current token buffer size as described above.

Process 900 may include “select acoustic model depending on, at least in part, detected sound types in the audio data” 916. Also as described herein, this refers to modifying the acoustic model, or selecting one of a set of acoustic models that respectively de-emphasize a different particular sound.

Process 900 may include “select language model depending, at least in part, on user activity” 918. This may include modifying the language model, or selecting a language model, that emphasizes a particular sub-vocabulary by modifying the weights for the words in that vocabulary.

Process 900 may include “perform ASR engine computations using the selected and/or modified models” 920 and as described above using the modified feature extraction settings, the selected acoustic model with or without acoustic scale factors described herein applied to the scores thereafter, and the selected language model with or without modified language model parameter(s). Process 900 may include “provide hypothetical words and/or phrases” 922, and to a language interpreter unit, by example, to form single sentence.

It will be appreciated that processes 300, 400, and/or 900 may be provided by sample ASR systems 10, 200, and/or 1000 to operate at least some implementations of the present disclosure. This includes operation of an environment identification unit 1010, parameter refinement unit 1012, and the ASR engine or unit 1014, as well as others, in speech recognition processing system 1000 (FIG. 10) and similarly for system 10 (FIG. 1). It will be appreciated that one or more operations of processes 300, 400 and/or 900 may be omitted or performed in a different order than that recited herein.

In addition, any one or more of the operations of FIGS. 3-4 and 9 may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

Referring to FIG. 10, an example speech recognition system 1000 is arranged in accordance with at least some implementations of the present disclosure. In various implementations, the example speech recognition processing system 1000 may have an audio capture device(s) 1002 to form or receive acoustical signal data. This can be implemented in various ways. Thus, in one form, the speech recognition processing system 1000 may be an audio capture device such as a microphone, and audio capture device 1002, in this case, may be the microphone hardware and sensor software, module, or component. In other examples, speech recognition processing system 1000 may have an audio capture device 1002 that includes or may be a microphone, and logic modules 1004 may communicate remotely with, or otherwise may be communicatively coupled to, the audio capture device 1002 for further processing of the acoustic data.

In either case, such technology may include a wearable device such as smartphone, wrist computer such as a smartwatch or an exercise wrist-band, or smart glasses, but otherwise a telephone, a dictation machine, other sound recording machine, a mobile device or an on-board device, or any combination of these. The speech recognition system used herein enables ASR for the ecosystem on small-scale CPUs (wearables, smartphones) since the present environment-sensitive systems and methods do not necessarily require connecting to the cloud to perform the ASR as described herein.

Thus, in one form, audio capture device 1002 may include audio capture hardware including one or more sensors as well as actuator controls. These controls may be part of an audio signal sensor module or component for operating the audio signal sensor. The audio signal sensor component may be part of the audio capture device 1002, or may be part of the logical modules 1004 or both. Such audio signal sensor component can be used to convert sound waves into an electrical acoustic signal. The audio capture device 1002 also may have an A/D converter, other filters, and so forth to provide a digital signal for speech recognition processing.

The system 1000 also may have, or may be communicatively coupled to, one or more other sensors or sensor subsystems 1038 that may be used to provide information about the environment in which the audio data was or is captured. Specifically, a sensor or sensors 1038 may include any sensor that that may indicate information about the environment in which the audio signal or audio data was captured including a global positioning system (GPS) or similar sensor, thermometer, accelerometer, gyroscope, barometer, magnetometer, galvanic skin response (GSR) sensor, facial proximity sensor, motion sensor, photo diode (light detector), ultrasonic reverberation sensor, electronic heart rate or pulse sensors, any of these or other technologies that form a pedometer, other health related sensors, and so forth.

In the illustrated example, the logic modules 1004 may include an acoustic front-end unit 1008 that provides pre-processing as described with unit 18 (FIG. 1) and that identifies acoustic features, an environment identification unit 1010, parameter refinement unit 1012, and ASR engine or unit 1014. The ASR engine 1014 may include a feature extraction unit 1015, an acoustic scoring unit 1016 that provides acoustic scores for the acoustic features, and a decoder 1018 that may be a WFST decoder and that provides a word sequence hypothesis, which may be in the form of a language or word transducer and/or lattice understood and as described herein. A language interpreter execution unit 1040 may be provided that determines the user intent and reacts accordingly. The decoder unit 1014 may be operated by, or even entirely or partially located at, processor(s) 1020, and which may include, or connect to, an accelerator 1022 to perform environment determination, parameter refinement, and/or ASR engine computations. The logic modules 1004 may be communicatively coupled to the components of the audio capture device 1002 and sensors 1038 in order to receive raw acoustic data and sensor data. The logic modules 1004 may or may not be considered to be part of the audio capture device.

The speech recognition processing system 1000 may have one or more processors 1020 which may include the accelerator 1022, which may be a dedicated accelerator, and one such as the Intel Atom, memory stores 1024 which may or may not hold the token buffers 1026 as well as word histories, phoneme, vocabulary and/or context databases, and so forth, at least one speaker unit 1028 to provide auditory responses to the input acoustic signals, one or more displays 1030 to provide images 1036 of text or other content as a visual response to the acoustic signals, other end device(s) 1032 to perform actions in response to the acoustic signal, and antenna 1034. In one example implementation, the speech recognition system 1000 may have the display 1030, at least one processor 1020 communicatively coupled to the display, at least one memory 1024 communicatively coupled to the processor and having a token buffer 1026 by one example for storing the tokens as explained above. The antenna 1034 may be provided for transmission of relevant commands to other devices that may act upon the user input. Otherwise, the results of the speech recognition process may be stored in memory 1024. As illustrated, any of these components may be capable of communication with one another and/or communication with portions of logic modules 1004 and/or audio capture device 1002. Thus, processors 1020 may be communicatively coupled to both the audio capture device 1002, sensors 1038, and the logic modules 1004 for operating those components. By one approach, although speech recognition system 1000, as shown in FIG. 10, may include one particular set of blocks or actions associated with particular components or modules, these blocks or actions may be associated with different components or modules than the particular component or module illustrated here.

As another alternative, it will be understood that speech recognition system 1000, or the other systems described herein (such as system 1100), may be a server, or may be part of a server-based system or network rather than a mobile system. Thus, system 1000, in the form of a server, may not have, or may not be directly connected to, the mobile elements such as the antenna, but may still have the same components of the speech recognition unit 1006 and provide speech recognition services over a computer or telecommunications network for example. Likewise, platform 1002 of system 1000 may be a server platform instead. Using the disclosed speech recognition unit on server platforms will save energy and provide better performance.

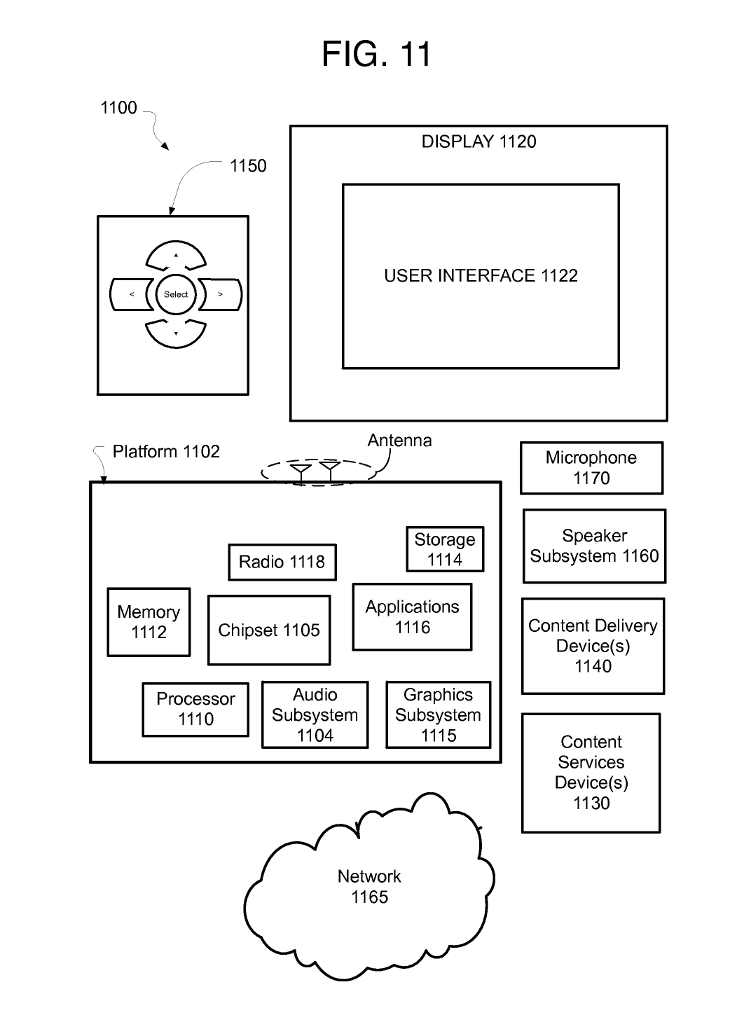

Referring to FIG. 11, an example system 1100 in accordance with the present disclosure operates one or more aspects of the speech recognition system described herein. It will be understood from the nature of the system components described below that such components may be associated with, or used to operate, certain part or parts of the speech recognition system described above. In various implementations, system 1100 may be a media system although system 1100 is not limited to this context. For example, system 1100 may be incorporated into a wearable device such as a smart watch, smart glasses, or exercise wrist-band, microphone, personal computer (PC), laptop computer, ultra-laptop computer, tablet, touch pad, portable computer, handheld computer, palmtop computer, personal digital assistant (PDA), cellular telephone, combination cellular telephone/PDA, television, other smart device (e.g., smartphone, smart tablet or smart television), mobile internet device (MID), messaging device, data communication device, and so forth.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102, at least one speaker or speaker subsystem 1160, at least one microphone 1170, and/or display 1120. Each of these components is described in greater detail below.

In various implementations, platform 1102 may include any combination of a chipset 1105, processor 1110, memory 1112, storage 1114, audio subsystem 1104, graphics subsystem 1115, applications 1116 and/or radio 1118. Chipset 1105 may provide intercommunication among processor 1110, memory 1112, storage 1114, audio subsystem 1104, graphics subsystem 1115, applications 1116 and/or radio 1118. For example, chipset 1105 may include a storage adapter (not depicted) capable of providing intercommunication with storage 1114.

Processor 1110 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device, or any other available storage. In various implementations, storage 1114 may include technology to increase the storage performance enhanced protection for valuable digital media when multiple hard drives are included, for example.

Audio subsystem 1104 may perform processing of audio such as environment-sensitive automatic speech recognition as described herein and/or voice recognition and other audio-related tasks. The audio subsystem 1104 may comprise one or more processing units and accelerators. Such an audio subsystem may be integrated into processor 1110 or chipset 1105. In some implementations, the audio subsystem 1104 may be a stand-alone card communicatively coupled to chipset 1105. An interface may be used to communicatively couple the audio subsystem 1104 to at least one speaker 1160, at least one microphone 1170, and/or display 1120.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, Display Port, wireless HDMI, and/or wireless HD compliant techniques. Graphics subsystem 1115 may be integrated into processor 1110 or chipset 1105. In some implementations, graphics subsystem 1115 may be a stand-alone card communicatively coupled to chipset 1105.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further implementations, the functions may be implemented in a consumer electronics device.

Radio 1190 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1190 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120, speaker 1160, and microphone 1170. Platform 1102 and/or content services device(s) 1130 may be coupled to a network 1165 to communicate (e.g., send and/or receive) media information to and from network 1165. Content delivery device(s) 1140 also may be coupled to platform 1102, speaker 1160, microphone 1170, and/or to display 1120.

In various implementations, content services device(s) 1130 may include a microphone, a cable television box, personal computer, network, telephone, Internet enabled devices or appliance capable of delivering digital information and/or content, and any other similar device capable of unidirectionally or bidirectionally communicating content between content providers and platform 1102 and speaker subsystem 1160, microphone 1170, and/or display 1120, via network 1165 or directly. It will be appreciated that the content may be communicated unidirectionally and/or bidirectionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of controller 1150 may be used to interact with user interface 1122, for example. In implementations, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1104 also may be used to control the motion of articles or selection of commands on the interface 1122.

Movements of the navigation features of controller 1150 may be replicated on a display (e.g., display 1120) by movements of a pointer, cursor, focus ring, or other visual indicators displayed on the display or by audio commands. For example, under the control of software applications 1116, the navigation features located on navigation controller 1150 may be mapped to virtual navigation features displayed on user interface 1122, for example. In implementations, controller 1150 may not be a separate component but may be integrated into platform 1102, speaker subsystem 1160, microphone 1170, and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example, or by auditory command. Program logic may allow platform 1102 to stream content to media adaptors or other content services device(s) 1130 or content delivery device(s) 1140 even when the platform is turned “off.” In addition, chipset 1105 may include hardware and/or software support for 8.1 surround sound audio and/or high definition (7.1) surround sound audio, for example. Drivers may include an auditory or graphics driver for integrated auditory or graphics platforms. In implementations, the auditory or graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102, speaker 1160, microphone 1170, and/or display 1120 may be an integrated unit. Display 1120, speaker 1160, and/or microphone 1170 and content service device(s) 1130 may be integrated, or display 1120, speaker 1160, and/or microphone 1170 and content delivery device(s) 1140 may be integrated, for example. These examples are not meant to limit the present disclosure.

In various implementations, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 11.

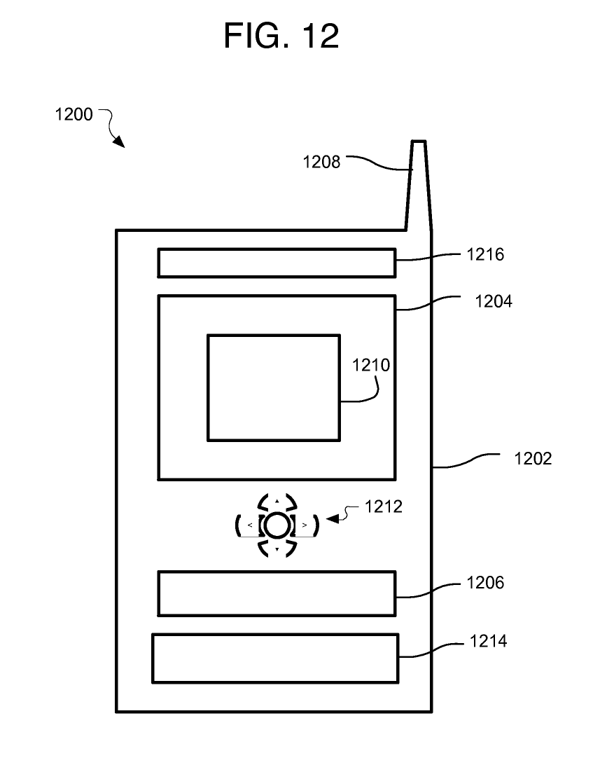

Referring to FIG. 12, a small form factor device 1200 is one example of the varying physical styles or form factors in which systems 1000 or 1100 may be embodied. By this approach, device 1200 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a smart device (e.g., smart phone, smart tablet or smart television), personal computer (PC), laptop computer, ultra-laptop computer, tablet, touch pad, portable computer, handheld computer, palmtop computer, personal digital assistant (PDA), cellular telephone, combination cellular telephone/PDA, television, mobile internet device (MID), messaging device, data communication device, and so forth, and any other on-board (such as on a vehicle) computer that may accept audio commands.

Examples of a mobile computing device also may include computers that are arranged to be worn by a person, such as a head-phone, head band, hearing aide, wrist computer (such as an exercise wrist band), finger computer, ring computer, eyeglass computer (such as smart glasses), belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 12, device 1200 may include a housing 1202, a display 1204 including a screen 1210, an input/output (I/O) device 1206, and an antenna 1208. Device 1200 also may include navigation features 1212. Display 1204 may include any suitable display unit for displaying information appropriate for a mobile computing device. I/O device 1206 may include any suitable I/O device for entering information into a mobile computing device. Examples for I/O device 1206 may include an alphanumeric keyboard, a numeric keypad, a touch pad, input keys, buttons, switches, rocker switches, software and so forth. Information also may be entered into device 1200 by way of microphone 1214. Such information may be digitized by a speech recognition device as described herein as well as a voice recognition devices and as part of the device 1200, and may provide audio responses via a speaker 1216 or visual responses via screen 1210. The implementations are not limited in this context.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

By one example, a computer-implemented method of speech recognition, comprises obtaining audio data including human speech; determining at least one characteristic of the environment in which the audio data was obtained; and modifying at least one parameter to be used to perform speech recognition and depending on the characteristic.

By another implementation, the method also may comprise that wherein the characteristic is associated with at least one of:

(1) the content of the audio data wherein the characteristic includes at least one of: an amount of noise in the background of the audio data, a measure of an acoustical effect in the audio data, and at least one identifiable sound in the audio data.

(2) wherein the characteristic is the signal-to-noise ratio (SNR) of the audio data; wherein the parameter is at least one of: (a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR; (b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and (c) an active token buffer size that is changed depending on the SNR.

(3) wherein the characteristic is a sound of at least one of: wind noise, heavy breathing, vehicle noise, sounds from a crowd of people, and a noise that indicates whether the audio device is outside or inside of a generally or substantially enclosed structure.

(4) wherein the characteristic is a feature in a profile of a user that indicates at least one potential acoustical characteristic of a user's voice including the gender of the user.

(5) wherein the characteristic is associated with at least one of: a geographic location of a device forming the audio data; a type or use of a place, building, or structure where the device forming the audio data is located; a motion or orientation of the device forming the audio data; a characteristic of the air around a device forming the audio data; and a characteristic of magnetic fields around a device forming the audio data.

(6) wherein the characteristic is used to determine whether a device forming the audio data is at least one of: being carried by a user of the device; on a user that is performing a specific type of activity; on a user that is exercising; on a user that is performing a specific type of exercise; and on a user that is in motion on a vehicle.

The method also may comprise selecting an acoustic model that de-emphasizes a sound in the audio data that is not speech and that is associated with the characteristic; and modifying the likelihoods of the words in a vocabulary search space depending, at least in part, on the characteristic.

By yet another implementation, a computer-implemented system of environment-sensitive automatic speech recognition comprises at least one acoustic signal receiving unit to obtain audio data including human speech; at least one processor communicatively connected to the acoustic signal receiving unit; at least one memory communicatively coupled to the at least one processor; an environment identification unit to determine at least one characteristic of the environment in which the audio data was obtained; and a parameter refinement unit to modify at least one parameter to be used to perform speech recognition on the audio data and depending on the characteristic.

By another example, the system provides that wherein the characteristic is associated with at least one of:

(1) the content of the audio data wherein the characteristic includes at least one of: an amount of noise in the background of the audio data, a measure of an acoustical effect in the audio data, and at least one identifiable sound in the audio data.

(2) wherein the characteristic is the signal-to-noise ratio (SNR) of the audio data; wherein the parameter is at least one of: (a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR; (b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and (c) an active token buffer size that is changed depending on the SNR.

(3) wherein the characteristic is a sound of at least one of: wind noise, heavy breathing, vehicle noise, sounds from a crowd of people, and a noise that indicates whether the audio device is outside or inside of a generally or substantially enclosed structure.

(4) wherein the characteristic is a feature in a profile of a user that indicates at least one potential acoustical characteristic of a user's voice including the gender of the user.

(5) wherein the characteristic is associated with at least one of: a geographic location of a device forming the audio data; a type or use of a place, building, or structure where the device forming the audio data is located; a motion or orientation of the device forming the audio data; a characteristic of the air around a device forming the audio data; and a characteristic of magnetic fields around a device forming the audio data.

(6) wherein the characteristic is used to determine whether a device forming the audio data is at least one of: being carried by a user of the device; on a user that is performing a specific type of activity; on a user that is exercising; on a user that is performing a specific type of exercise; and on a user that is in motion on a vehicle.

Also, the system may comprise the parameter refinement unit to select an acoustic model that de-emphasizes a sound in the audio data that is not speech and that is associated with the characteristic; and modify the likelihoods of the words in a vocabulary search space depending, at least in part, on the characteristic.

By one approach, at least one computer readable medium comprises a plurality of instructions that in response to being executed on a computing device, causes the computing device to: obtain audio data including human speech; determine at least one characteristic of the environment in which the audio data was obtained; and modify at least one parameter to be used to perform speech recognition on the audio data and depending on the characteristic.

By another approach, the instructions include that wherein the characteristic is associated with at least one of:

(1) the content of the audio data wherein the characteristic includes at least one of: an amount of noise in the background of the audio data, a measure of an acoustical effect in the audio data, and at least one identifiable sound in the audio data.

(2) wherein the characteristic is the signal-to-noise ratio (SNR) of the audio data; wherein the parameter is at least one of: (a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR; (b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and (c) an active token buffer size that is changed depending on the SNR.

(3) wherein the characteristic is a sound of at least one of: wind noise, heavy breathing, vehicle noise, sounds from a crowd of people, and a noise that indicates whether the audio device is outside or inside of a generally or substantially enclosed structure.

(4) wherein the characteristic is a feature in a profile of a user that indicates at least one potential acoustical characteristic of a user's voice including the gender of the user.

(5) wherein the characteristic is associated with at least one of: a geographic location of a device forming the audio data; a type or use of a place, building, or structure where the device forming the audio data is located; a motion or orientation of the device forming the audio data; a characteristic of the air around a device forming the audio data; and a characteristic of magnetic fields around a device forming the audio data.

(6) wherein the characteristic is used to determine whether a device forming the audio data is at least one of: being carried by a user of the device; on a user that is performing a specific type of activity; on a user that is exercising; on a user that is performing a specific type of exercise; and on a user that is in motion on a vehicle.

Also, the medium wherein the instructions cause the computing device to select an acoustic model that de-emphasizes a sound in the audio data that is not speech and that is associated with the characteristic; and modify the likelihoods of the words in a vocabulary search space depending, at least in part, on the characteristic.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of speech recognition, comprising:
obtaining audio data including human speech;
determining at least one characteristic of the environment in which the audio data was obtained; and
modifying at least one parameter to be used to perform speech recognition and depending on the characteristic.

2. The method of claim 1 wherein the characteristic is associated with the content of the audio data.

3. The method of claim 1 wherein the characteristic includes at least one of:
an amount of noise in the background of the audio data,
a measure of an acoustical effect in the audio data, and
at least one identifiable sound in the audio data.

4. The method of claim 1 wherein the characteristic is the signal-to-noise ratio (SNR) of the audio data.

5. The method of claim 4 wherein the parameter is the beamwidth of a language model to generate possible portions of speech of the audio data and that is adjusted depending on the signal-to-noise ratio of the audio data.

6. The method of claim 5 wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data.

7. The method of claim 5 wherein the beamwidth is lower for higher SNR than the beamwidth for lower SNR,

8. The method of claim 4 wherein the parameter is an acoustic scale factor that is applied to acoustic scores to be used on a language model to generate possible portions of speech of the audio data and that is adjusted depending on the signal-to-noise ratio of the audio data.

9. The method of claim 8 wherein the acoustic scale factor is selected depending on a desired WER in addition to the SNR.

10. The method of claim 8 wherein an active token buffer size is changed depending on the SNR.

11. The method of claim 1 wherein the characteristic is a sound of at least one of:
wind noise,
heavy breathing,
vehicle noise,
sounds from a crowd of people, and
a noise that indicates whether the audio device is outside or inside of a generally or substantially enclosed structure.

12. The method of claim 1 wherein the characteristic is a feature in a profile of a user that indicates at least one potential acoustical characteristic of a user's voice including the gender of the user.

13. The method of claim 1 comprising selecting an acoustic model that de-emphasizes a sound in the audio data that is not speech and that is associated with the characteristic.

14. The method of claim 1 wherein the characteristic is associated with at least one of:
a geographic location of a device forming the audio data;
a type or use of a place, building, or structure where the device forming the audio data is located;
a motion or orientation of the device forming the audio data;
a characteristic of the air around a device forming the audio data; and
a characteristic of magnetic fields around a device forming the audio data.

15. The method of claim 1 wherein the characteristic is used to determine whether a device forming the audio data is at least one of:
being carried by a user of the device;
on a user that is performing a specific type of activity;
on a user that is exercising;
on a user that is performing a specific type of exercise; and
on a user that is in motion on a vehicle.

16. The method of claim 1 comprising modifying the likelihoods of the words in a vocabulary search space depending, at least in part, on the characteristic.

17. The method of claim 1 wherein the characteristic is associated with at least one of:
(1) the content of the audio data wherein the characteristic includes at least one of:
an amount of noise in the background of the audio data,
a measure of an acoustical effect in the audio data, and
at least one identifiable sound in the audio data;
(2) wherein the characteristic is the signal-to-noise ratio (SNR) of the audio data;
wherein the parameter is at least one of:
(a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR;
(b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and
(c) an active token buffer size that is changed depending on the SNR;
(3) wherein the characteristic is a sound of at least one of:
wind noise,
heavy breathing,
vehicle noise,
sounds from a crowd of people, and
a noise that indicates whether the audio device is outside or inside of a generally or substantially enclosed structure;
(4) wherein the characteristic is a feature in a profile of a user that indicates at least one potential acoustical characteristic of a user's voice including the gender of the user;
(5) wherein the characteristic is associated with at least one of:
a geographic location of a device forming the audio data;
a type or use of a place, building, or structure where the device forming the audio data is located;
a motion or orientation of the device forming the audio data;
a characteristic of the air around a device forming the audio data; and
a characteristic of magnetic fields around a device forming the audio data;
(6) wherein the characteristic is used to determine whether a device forming the audio data is at least one of:
being carried by a user of the device;
on a user that is performing a specific type of activity;
on a user that is exercising;
on a user that is performing a specific type of exercise; and
on a user that is in motion on a vehicle; and
the method comprising selecting an acoustic model that de-emphasizes a sound in the audio data that is not speech and that is associated with the characteristic; and
modifying the likelihoods of the words in a vocabulary search space depending, at least in part, on the characteristic.

18. A computer-implemented system of speech recognition comprising:
at least one acoustic signal receiving unit to obtain audio data including human speech;
at least one processor communicatively connected to the acoustic signal receiving unit;
at least one memory communicatively coupled to the at least one processor;
an environment identification unit to determine at least one characteristic of the environment in which the audio data was obtained; and
a parameter refinement unit to modify at least one parameter to be used to perform speech recognition on the audio data and depending on the characteristic.

19. The system of claim 18 wherein the characteristic is signal-to-noise ratio.

20. The system of claim 18 wherein the parameter is at least one of:
(1) an acoustic scale factor applied to acoustic scores, or
(2) beamwidth,
both being of a language model and that is modified depending on the characteristic.

21. The system of claim 18 wherein the characteristic is a type of sound that is detectable in the audio data and that is not speech, and the parameter refinement unit to select an acoustic model that de-emphasizes the detected type of sound.

22. The system of claim 18 comprising adjusting the weights of words in a vocabulary search space depending on the characteristic.

23. The system of claim 18 wherein the characteristic is associated with at least one of:
(1) the content of the audio data wherein the characteristic includes at least one of:
an amount of noise in the background of the audio data,
a measure of an acoustical effect in the audio data, and
at least one identifiable sound in the audio data;
(2) wherein the characteristic is the signal-to-noise ratio (SNR) of the audio data;
wherein the parameter is at least one of:
(a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR;
(b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and
(c) an active token buffer size that is changed depending on the SNR;
(3) wherein the characteristic is a sound of at least one of:
wind noise,
heavy breathing,
vehicle noise,
sounds from a crowd of people, and
a noise that indicates whether the audio device is outside or inside of a generally or substantially enclosed structure;
(4) wherein the characteristic is a feature in a profile of a user that indicates at least one potential acoustical characteristic of a user's voice including the gender of the user;
(5) wherein the characteristic is associated with at least one of:
a geographic location of a device forming the audio data;
a type or use of a place, building, or structure where the device forming the audio data is located;
a motion or orientation of the device forming the audio data;
a characteristic of the air around a device forming the audio data; and
a characteristic of magnetic fields around a device forming the audio data;
(6) wherein the characteristic is used to determine whether a device forming the audio data is at least one of:
being carried by a user of the device;
on a user that is performing a specific type of activity;
on a user that is exercising;
on a user that is performing a specific type of exercise; and
on a user that is in motion on a vehicle; and
the system wherein the parameter refinement unit to select an acoustic model that de-emphasizes a sound in the audio data that is not speech and that is associated with the characteristic; and
modify the likelihoods of the words in a vocabulary search space depending, at least in part, on the characteristic.

24. At least one computer readable medium comprising a plurality of instructions that in response to being executed on a computing device, causes the computing device to:
obtain audio data including human speech;
determine at least one characteristic of the environment in which the audio data was obtained; and
modify at least one parameter to be used to perform speech recognition on the audio data and depending on the characteristic.

25. The medium of claim 24 wherein the characteristic is associated with at least one of:
(1) the content of the audio data wherein the characteristic includes at least one of:
an amount of noise in the background of the audio data,
a measure of an acoustical effect in the audio data, and
at least one identifiable sound in the audio data;
(2) wherein the characteristic is the signal-to-noise ratio (SNR) of the audio data;
wherein the parameter is at least one of:
(a) the beamwidth of a language model to generate possible portions of speech of the audio data and that is adjusted depending on the signal-to-noise ratio of the audio data; wherein the beamwidth is selected depending on a desirable word error rate (WER) value that is the number of errors relative to the number of words spoken, and desirable real time factor (RTF) value that is the time needed for processing an utterance relative to the duration of the utterance, in addition to the SNR of the audio data; wherein the beamwidth is lower for higher SNR than the beamwidth for lower SNR;
(b) an acoustic scale factor that is applied to acoustic scores to be used on a language model to generate possible portions of speech of the audio data and that is adjusted depending on the signal-to-noise ratio of the audio data; wherein the acoustic scale factor is selected depending on a desired WER in addition to the SNR, and
(c) an active token buffer size that is changed depending on the SNR;
(3) wherein the characteristic is a sound of at least one of:
wind noise,
heavy breathing,
vehicle noise,
sounds from a crowd of people, and
a noise that indicates whether the audio device is outside or inside of a generally or substantially enclosed structure;
(4) wherein the characteristic is a feature in a profile of a user that indicates at least one potential acoustical characteristic of a user's voice including the gender of the user;
(5) wherein the characteristic is associated with at least one of:
a geographic location of a device forming the audio data;
a type or use of a place, building, or structure where the device forming the audio data is located;
a motion or orientation of the device forming the audio data;
a characteristic of the air around a device forming the audio data; and
a characteristic of magnetic fields around a device forming the audio data;
(6) wherein the characteristic is used to determine whether a device forming the audio data is at least one of:
being carried by a user of the device;
on a user that is performing a specific type of activity;
on a user that is exercising;
on a user that is performing a specific type of exercise; and
on a user that is in motion on a vehicle; and
the medium wherein the instructions cause the computing device to select an acoustic model that de-emphasizes a sound in the audio data that is not speech and that is associated with the characteristic; and
modify the likelihoods of the words in a vocabulary search space depending, at least in part, on the characteristic.
